(19) United States
(12) Patent Application Publication
(10) Pub. No.: US 2026/0028950 A1
(43) Pub. Date: Jan. 29, 2026

(54) LIQUID INJECTION SYSTEM, LIQUID INJECTED ENGINE SYSTEM AND METHOD OF CONTROLLING A LIQUID INJECTION SYSTEM

(71) Applicant: Cummins Power Generation Inc., Minneapolis, MN (US)

(72) Inventors: Justin J. Moe, Forest Lake, MN (US); Shubhranshu Verma, Medina, MN (US); Hasan Mohammed, Charleston, SC (US); Robert Charles Borregard, Charleston, SC (US)

(73) Assignee: Cummins Power Generation Inc., Minneapolis, MN (US)

(21) Appl. No.: 18/998,897

(22) PCT Filed: Jul. 28, 2022
(86) PCT No.: PCT/US2022/038716

§ 371 Date: Jan. 27, 2025

(51) Int. Cl. F02M 25/022; F02D 41/14; F02M 25/025

(52) U.S. Cl. CPC F02M 25/0227; F02D 41/1461; F02M 25/0222; F02M 25/025; F02D 2200/0406; F02D 2200/0414; F02D 2200/0418

(57) ABSTRACT

Systems and methods include processing circuits comprising one or more memory devices coupled to one or more processors, the one or more memory devices configured to store instructions thereon that, when executed by the one or more processors, cause the one or more processors to receive temperature information indicative of a temperature within an air intake, receive humidity information indicative of an inlet air humidity at the air intake, receive pressure information indicative of an air pressure within the air intake, determine a dew point temperature limit based on the temperature information, the humidity information, and the pressure information, determine an exhaust emissions output, determine a liquid flow rate based on the dew point temperature limit, the liquid flow rate reducing the exhaust emissions output, and control at least one of a pump or a valve to provide the liquid flow rate.

### FIELD

The present disclosure relates generally to engine humidification systems. More specifically, the present disclosure relates to liquid injection control systems for engines.

### BACKGROUND

Many engine systems have air introduction systems that are susceptible to water ingress. Water ingress can lead to corrosion, and, in addition, humidity may affect components of such systems.

### SUMMARY

One embodiment relates to a liquid injection system for an engine system that includes one or more processing circuits including one or more memory devices coupled to one or more processors, the one or more memory devices configured to store instructions thereon that, when executed by the one or more processors, cause the one or more processors to receive temperature information indicative of a temperature within an air intake; receive humidity information indicative of an inlet air humidity at the air intake; receive pressure information indicative of an air pressure within the air intake; determine a dew point temperature limit based on the temperature information, the humidity information, and the pressure information; determine an exhaust emissions output; determine a liquid flow rate based on the dew point temperature limit, the liquid flow rate allowing for a reduction in the exhaust emissions output; and control at least one of a pump or an injector valve to provide the liquid flow rate.

Another embodiment relates to liquid injected engine system that includes an water manifold, a water tank, a water pump fluidly coupled to the water tank, a water solenoid valve selectively coupling a water injector nozzle with the water pump, and a controller structured to determine a dew point temperature limit based on temperature, pressure, and humidity information of the water manifold, determine a condensation margin limit based on the dew point temperature limit, determine a liquid flow rate based on the dew point temperature limit and the condensation margin limit, and control the water pump and the solenoid water valve to provide the liquid flow rate to the water injector nozzle.

Another embodiment relates to a method of controlling a liquid injection system for an engine. The method includes receiving temperature information indicative of a temperature within an air intake, receiving humidity information indicative of an inlet air humidity at the air intake, receiving pressure information indicative of an air pressure within the air intake, determining a dew point temperature limit based on the temperature information, the humidity information, and the pressure information, determining an exhaust emissions output, determining a liquid flow rate based on the dew point temperature limit, the liquid flow rate allowing for a reduction of the exhaust emissions output, and controlling at least one of a pump or a water solenoid valve to provide the liquid flow rate.

It should be appreciated that all combinations of the foregoing concepts and additional concepts discussed in greater detail below are contemplated as being part of the subject matter disclosed herein. In particular, all combinations of claimed subject matter appended at the end of this disclosure are contemplated as being part of the subject matter disclosed herein.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic diagram of a liquid injected engine system, according to some embodiments.

FIG. 2 is a schematic diagram of a controller of the liquid injected engine system of FIG. 1, according to some embodiments.

FIG. 3 is a flow diagram of control logic processing of the controller of FIG. 2, according to some embodiments.

FIG. 4 is a flow diagram of a method of operating the liquid injected engine system of FIG. 1, according to some embodiments.

FIG. 5 is a flow diagram of the method of operating the liquid injected engine system of FIG. 1, according to some embodiments.

FIG. 6 is a flow diagram of the method of operating the liquid injected engine system of FIG. 1, according to some embodiments.

Reference is made to the accompanying drawings described above throughout the following detailed description. In the drawings, similar symbols typically identify similar components, unless context dictates otherwise. The illustrative implementations described in the following detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Following below are more detailed descriptions of various concepts related to, and implementations of, methods and systems for controlling a liquid injection system for an engine system.

Referring to the figures generally, the various embodiments disclosed herein relate to systems and methods for providing on-engine solutions for reducing engine exhaust emissions without the use of exhaust aftertreatment systems. Many existing engines used in data centers and other installations for powering generator sets are intended to provide high power output and to be fuel efficient. Many such engine may require an aftertreatment system to achieve required nitrogen oxide (NOx) emission levels (e.g., as set by a regulatory authority). An engine humidification system as described herein can reduce NOx emissions on standby diesel generator sets or other engines. The system injects a fine mist of liquid, e.g., water, after a turbocharger to increase the humidity of the combustion air. Although water is referred to below in the exemplary embodiments, it should be appreciated that the techniques described herein are not limited to water and are applicable to other liquids. In some embodiments, a reduction in NOx can be provided using the liquid injection system (as compared to when the system is not supplied). The control techniques described herein allow for a reduction in emissions, in particular NOx. In some embodiments, a reduction in NOx of between about 5% to about 40%, of between about 10% to about 20%, of between about 10% to about 30% or of between about 10% to about 40% can be achieved.

In some embodiments, the liquid injection system determines a dew point temperature limit in a water manifold, as discussed in more detail below. In some embodiments, once the dew point temperature limit is determined, the liquid injection system then performs control to reduce NOx emissions. Such a control to reduce NOx emissions can be carried out while inhibiting condensation in the water manifold. In some embodiments, no additional sensors are used to operate the liquid injection system besides the sensors already provided with the engine (e.g., a “trican” sensor, “tri-sensor” or “combination sensor” as discussed in more detail below). Thus, such a system is conducive for retrofitting of older engines that might otherwise require replacement or expensive upgrades to maintain compliance with changing emissions regulations.

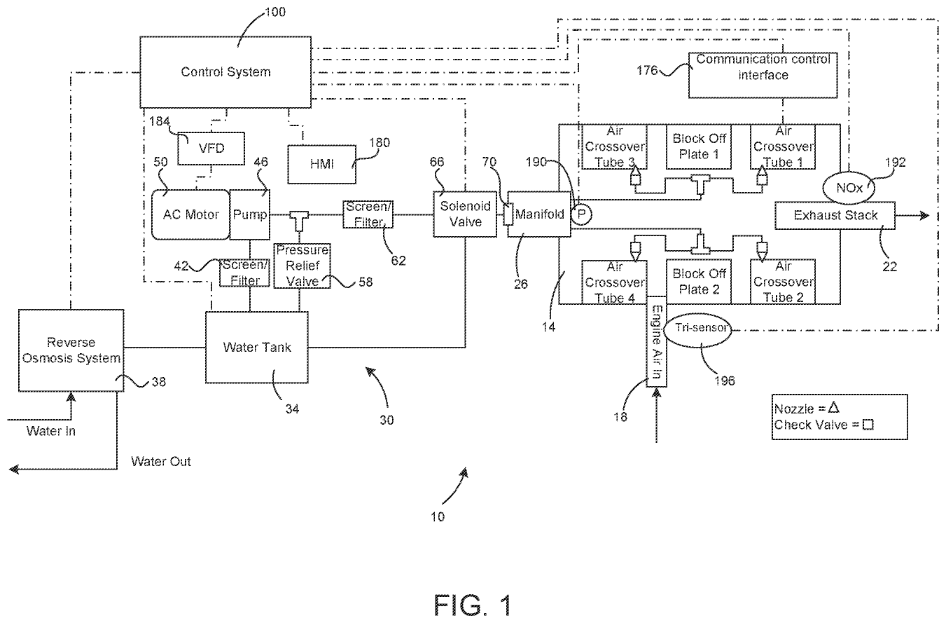

As shown in FIG. 1, a liquid injected engine system 10 includes an engine 14 that includes a fresh air intake 18, and exhaust gas output 22, and a water manifold 26. In some embodiments, the engine 14 is a turbocharged engine that includes air crossover tubes and block off plates. For example, as seen in FIG. 1, the liquid injected engine system 10 may include a first block off plate (block off plate 1), a second block off plate (block off plate 2), and two pairs of air crossover tubes. The first pair, for example, includes air crossover tube 1 and air crossover tube 2 opposed to each other on opposite sides of exhaust stack 22. The second pair includes air crossover tube 3 and air crossover tube 4 on opposed to each other on opposite sides of a manifold pressure sensor 190 and on an opposite side of the block off plates (block off plate 1 and block off plate 2) from the first pair of crossover tubes.

In some embodiments, the engine 14 is an internal combustion engine that provides mechanical power to a generator as a part of a generator set for providing electrical energy. For example, the engine 14 may be a part of a generator set used to power a structure, equipment or facility demanding power. The structure, facility or equipment may be, for example, a data center, another building, a marine generator set, a locomotive generator set, or the engine 14 may be configured as an engine in another system, as desired. In some embodiments, data centers may be located in remote locations, or may have large power demands requiring a large number of generator sets. The liquid injected engine system 10 is structured to provide mechanical power while reducing the production of emissions such as NOx that exit the exhaust gas output 22. In many locations, it is desirable to maintain the emissions from the exhaust gas output 22 below a threshold level. Further, in some embodiments, it is advantageous to maintain desired emissions levels without the implementation of complex aftertreatment systems or with a reduction in the number of such aftertreatment systems. The liquid injected engine system 10 utilizes liquid injection to the water manifold 26 to reduce NOx emissions produced by the engine 14 without the use of an aftertreatment system.

Further, in some embodiments, various components described above may be combined with other components in a liquid injected engine system. For example, in some embodiments, a liquid injection system 30 of the liquid injected engine system 10 includes water manifold 26, water tank 34, water pump 46, water solenoid valve 66 coupling a water injector nozzle 70 with water pump 46, and a controller 100. As described in greater detail below, the controller 100 is configured to determine a dew point temperature limit based on temperature, pressure, and humidity information of the water manifold; determine a condensation margin limit based on the dew point temperature limit; determine a liquid flow rate based on the dew point temperature limit and the condensation margin limit; and control the water pump 46 and the water solenoid valve 66 to provide the liquid flow rate to the injector nozzle 70.

As noted above, in some embodiments, the liquid injection system 30 of the liquid injected engine system 10 includes the water tank 34. In some embodiments, the water tank 34 is arranged to receive a flow of water from a reverse osmosis system 38 or another water treatment system. In some embodiments, the water treatment system is eliminated. In some embodiments, the water tank 34 is filled periodically. In some embodiments, the water tank 34 is filled periodically and is not connected to a continuous water supply.

In some embodiments, water from the water tank 34 is filtered through a water filter or screen 42 before being supplied to the pump 46. The pump 46 is driven by a motor 50. In some embodiments the motor 50 is an alternating current (AC) motor. A pressure relief valve 58 receives flow from the pump 46 and returns water to the water tank 34 when pressure exceeds a threshold water system pressure.

Pressured water from the pump 46 is again filtered through a water filter or screen 62 and is received by a solenoid operated dosing valve 66 which can be configured as a water solenoid valve. The solenoid valve 66 provides water to injector nozzles 70 within the manifold 26. The injector nozzles 70 provide a mist of water into a fuel stream combusted by the engine 14 within the manifold 26.

In some embodiments, controller 100 is structured to communicate with one or more actuators and one or more sensors of the liquid injected engine system 10. The controller 100 controls operation of the solenoid valve 66 to provide water to the injector nozzles 70, a variable frequency drive (VFD) 184 to drive the motor 50, and a human machine interface (HMI) 180. The water pump 46 can be controlled, e.g., by sending control commands, to the VFD 184 to provide the liquid flow rate. The controller 100 receives information from sensors and operates the liquid injection system 30 to reduce emissions. In some embodiments, the controller 100 operates the liquid injection system 30 to reduce emissions while reducing or inhibiting the formation of condensation within the manifold. The controller 100 determines a dew point temperature and pressure, sets a margin limit relative to the determined dew point temperature and pressure, and controls liquid flow to the injector nozzles 70 to reduce emissions while maintaining conditions below the margin limit.

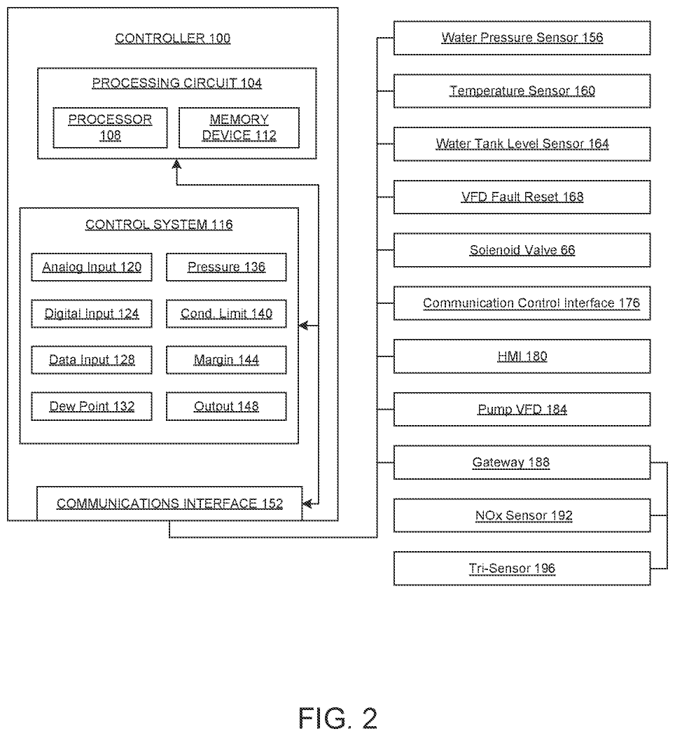

As the components of FIG. 1 are shown to be embodied in the liquid injected engine system 10, the controller 100 may be structured as one or more electronic control units (ECU). The controller 100 may be separate from or included with at least one of an exhaust aftertreatment control unit, a generator control module, or an engine control module, etc., alone or in any combination. The function and structure of the controller 100 is described in greater detail in FIG. 2.

Referring now to FIG. 2, a schematic diagram of the controller 100 of the liquid injected engine system 10 of FIG. 1 is shown according to an example embodiment. As shown in FIG. 2, the controller 100 includes a processing circuit 104 having a processor 108 and a memory device 112, a control system 116 having an analog input circuit 120, a digital input circuit 124, a data input circuit 128, a dew point circuit 132, a pressure circuit 136, a condensation limit circuit 140, a margin circuit 144, and an output circuit 148, and a communications interface 152. Generally, the controller 100 is structured to determine a dew point temperature and pressure of the water manifold 26, determine a margin limit relative to the determined dew point temperature and pressure, and control the liquid injection system 30 to reduce engine emissions while maintaining conditions within the manifold 26 below the margin limit.

The controller 100 is communicably connected to a plurality of sensors. In some embodiments, the controller 100 is configured to communicate with at least one water pressure sensor, at least one temperature sensor, and at least one water tank level sensor, for example. The controller 100 in some embodiments is configured to communicate with a water pressure sensor 156 positioned to measure a pressure of the water at the injector nozzles 70, a temperature sensor 160 positioned in the exhaust gas flow, a water tank level sensor 164, a VFD fault reset 168, the solenoid valve 66, the HMI 180, the pump VFD 184, and one or more routers. For example, the controller 100 is configured to communicate with an information router in the form of a communication control interface 176, and an information router in the form of a gateway 188. The gateway 188 is configured to receive information from at least a manifold pressure sensor 190, a NOx sensor 192 positioned in the exhaust output 22, and a combination sensor 196. In some embodiments, information is displayed from at least the NOx sensor 192 on the HMI 180. In some embodiments, the gateway 188 is a gateway that complies with Society of Automotive Engineers J1939 standards for a communication vehicle network. In some embodiments, the combination sensor 196 can be configured to measure three primary parameters, and is also referred to as a “tri sensor.”

In some embodiments, the combination sensor 196 is configured as a pressure, temperature and humidity sensor 196 positioned in the engine intake 18 to measure an intake air temperature, an intake air humidity, and an intake air pressure. The liquid injected engine system 10 can include other sensors for providing information to the controller 100. The humidity measured by sensor 196 can be relative humidity. For example, a boost pressure sensor and a manifold temperature sensor can be included. In some embodiments, the controller 100 is structured to communicate with a sensor array of an engine system 10 provided by a third party (e.g., a supplier) different than the supplier of the controller 100. The controller 100 is structured to receive the available information from the sensor array and provide the control functionality discussed herein.

In one configuration, the circuits of the control system 116 are embodied as machine or computer-readable media that is executable by a processor, such as processor 108. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the circuits of the control system 116 are embodied as hardware units, such as electronic control units. As such, the circuits of the control system 116 may be embodied as one or more circuitry components including, but not limited to, processing circuitry, network interfaces, peripheral devices, input devices, output devices, sensors, etc. In some embodiments, the circuits of the control system 116 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the circuits of the control system 116 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on. The circuits of the control system 116 may also include programmable hardware devices such as field programmable gate arrays, programmable array logic, programmable logic devices or the like. The circuits of the control system 116 may include one or more memory devices for storing instructions that are executable by the processor(s) of the circuits of the control system 116. The one or more memory devices and processor(s) may have the same definition as provided below with respect to the memory device 112 and processor 108. In some hardware unit configurations, the circuits of the control system 116 may be dispersed throughout separate locations in a structure. Alternatively and as shown, the circuits of the control system 116 may be embodied in or within a single unit/housing, which is shown as the controller 100.

In the example shown in FIG. 2, the controller 100 includes the processing circuit 104 having the processor 108 and the memory device 112. The processing circuit 104 may be structured or configured to execute or implement the instructions, commands, and/or control processes described herein with respect to circuits of the control system 116. The depicted configuration represents the circuits of the control system 116 as machine or computer-readable media. However, as mentioned above, this illustration is not meant to be limiting as the present disclosure contemplates other embodiments where one or more of the circuits of the control system 116, or at least one circuit of the circuits of the control system 116, is configured as a hardware unit. All such combinations and variations are intended to fall within the scope of the present disclosure.

The hardware and data processing components used to implement the various processes, operations, illustrative logics, logical blocks, modules and circuits (e.g., the processing circuit 104 provided with processor 108) described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., circuits of the control system 116 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 112 (e.g., memory, memory unit, storage device) may include one or more devices (e.g., RAM, ROM, flash memory, hard disk storage) for storing data and/or computer code for completing or facilitating the various processes, layers and modules described in the present disclosure. The memory device 112 may be communicably connected to the processor 108 to provide computer code or instructions to the processor 108 for executing at least some of the processes described herein. Moreover, the memory device 112 may be or include tangible, non-transient volatile memory or non-volatile memory. Accordingly, the memory device 112 may include database components, object code components, script components, or any other type of information structure for supporting the various activities and information structures described herein.

In some embodiments, the analog input circuit 120 is structured to receive an injection water pressure from the water pressure sensor 156, and an exhaust stack temperature from the temperature sensor 160. In some embodiments, the analog input circuit 120 includes a thermocouple to analog input converter. The analog input circuit 120 is structured to receive information from any other analog sensors or system of the engine system 10.

In some embodiments, the digital input circuit 124 is structured to receive information from the water tank level sensor 164 and from any other digital sensors or system of the engine system 10. For example, the data input circuit 128 is structured to receive information from the communication control interface 176, the HMI 180, the pump VFD 184, and a gateway 188. In some embodiments, the communication control interface 176 provides engine speed, total engine load or generator load (e.g., in kW), boost pressure, intake manifold pressure, and generator status. In some embodiments, communication control interface 176 is configured to provide information relating to a generator set load and an engine temperature. In some embodiments, the communication control interface 176 can provide other information, as desired. In some embodiments, gateway 188 provides various inlet and exhaust information, among other information.

For example, in some embodiments, the gateway 188 provides an exhaust stack pressure, and inlet air information supplied from a combination sensor 196 as discussed further below. In some embodiments, gateway 188 supplies information relating to an inlet air pressure from the combination sensor 196, an inlet air temperature from the combination sensor 196, and inlet air humidity from the combination sensor 196. The inlet air humidity may be at least one of a relative humidity or a specific humidity. In some embodiments, the gateway 188 is further configured to provide an exhaust NOx level from the NOx sensor 192, an intake air mass flow rate, a NOx gain, a NOx offset, and a NOx pressure correlation that correlates a NOx pressure at the exhaust stack 22 with boost pressure or another parameter impacting NOx reduction feedback information. In some embodiments, the gateway 188 supplies status information such as status information relating to one or more of a NOx sensor status, a humidity sensor status, and an operational status of one or more engine control modules or engine control units. In some embodiments, the data input circuit 128 receives data packets or raw data streams from the engine system 10, a generator, or other components of the engine system 10. The data input circuit 128 also provides or transmits information to one or more of the communication control interface 176, the HMI 180, the pump VFD 184, and the gateway 188.

In some embodiments, a liquid injection system for an engine system includes one or more processing circuits (e.g., implemented via processor 108) including one or more memory devices (e.g., memory devices 112) coupled thereto. The one or more memory devices configured to store instructions thereon that, when executed by the one or more processors, cause the one or more processors to receive temperature information indicative of a temperature within an air intake; receive humidity information indicative of an inlet air humidity at the air intake; receive pressure information indicative of an air pressure within the air intake; determine a dew point temperature limit based on the temperature information, the humidity information, and the pressure information; determine an exhaust emissions output; determine a liquid flow rate based on the dew point temperature limit, the liquid flow rate allowing for a reduction of the exhaust emissions output; and control at least one of a pump or a valve to provide the liquid flow rate.

In some embodiments, the dew point circuit 132 is structured to determine a dew point temperature within the manifold 26 based on the information received by the analog input circuit 120, the digital input circuit 124, and the data input circuit 128.

In some embodiments, the pressure circuit 136 is structured to determine a dew point pressure within the manifold 26 based on the information received by the analog input circuit 120, the digital input circuit 124, and the data input circuit 128.

In some embodiments, the condensation limit circuit 140 is structured to determine a condensation limit at which condensation is predicted to form in the manifold 26 based on determinations of the dew point circuit 132 and the pressure circuit 136.

In some embodiments, the dew point circuit 132, the pressure circuit 136, and the condensation limit circuit 140 communicate with each other. The pressure circuit 136 and dew point circuit 132 are respectively configured to determine pressure and dew point related information. In some embodiments, the dew point circuit 132, the pressure circuit 136, and the condensation limit circuit 140 are communicatively coupled to allow determination of the following:

$$a . Amb\_Sat \_Vapor \_Press ( mbar ) = a * EXP ( ( b * Amb\_Temp ) / ( Amb\_Temp + c ) )$$

$$b . Amb\_Vapor \_Press ( mbar ) = Amb\_Sat \_Vapor \_Press * Amb\_Rel \_Humidity / 100$$

$$c . Amb\_Spec \_Humidity ( kg / kg ) = d * Amb\_Vapor \_Press / ( Amb\_Press - ( e * Amb\_Vapor \_Press ) ) )$$

$$d . IntakeMan\_Spec \_Humidity ( kg / kg ) = Amb\_Spec \_Humidity + ( Water\_Flow / Air\_Flow )$$

$$e . Intake\_Man \_Sat \_Vapor \_Press ( mbar ) = a * EXP ( ( b * Intake\_Man \_Temp ) / ( Intake\_Man \_Temp + c ) )$$

$$f . Intake\_Man \_Vapor \_Press ( mbar ) = IntakeMan\_Spec \_Humidity * Intake\_Man \_Press / ( d + e * Intake\_Man \_Spec \_Humidity / 1000 )$$

$$g . Intake\_Man \_Rel \_Humidity ( \% ) = 100 * Intake\_Man \_Vapor \_Press / Intake\_Man \_Sat \_Vapor \_Press$$

$$h . Dew\_Temp ( C ) = ( LN ( Intake\_Man \_Vapor \_Press \_f ) * c ) / ( b - LN ( Intake\_Man \_Vapor \_Press \_f ) ) ,$$

where Amb_Sat_Vapor_Press is the ambient saturation vapor pressure, the Amb_Vapor_Press is the ambient vapor pressure, the Amb_Temp is the ambient temperature, the Amb_Rel_Humidity is the ambient relative humidity, the Amb_Spec_Humidity is the ambient specific humidity, the Amb_Press in the ambient pressure, the Intakeman_Spec_humidity is the intake manifold specific humidity, the Water_Flow is the water flow rate, the Air Flow is the air flow rate, the Intake_Man_Sat_Vapor_Press in the intake manifold saturation vaport pressure, the Intake_Man_Temp is the intake manifold temperature, the Intake_Man_Vapor_Press is the intake manifold vapor pressure, the IntakeMan_Spec_Humidity is the intake manifold specific humidity, the intake_Man_Press is the intake manifold pressure, the Intake_Man_Rel_Humidity is the intake manifold relative humidity, and the Dew_Temp is the dew point temperature. In some embodiments scaling factors a, b, c d, e and f may vary according to various parameters and/or system requirements. In some embodiments, a is 6.122, b is 17.67, c is 243.5, d is 0.622, e is 0.378 and f is 6.112, although it should be appreciated that the exemplary embodiments described herein are not limited to any of the foregoing values.

The margin circuit 144 is structured to determine a condensation margin limit. In some embodiments, the condensation margin limit is a calibratable constant defined by the user. For example, the condensation margin limit can be a temperature value (e.g., a temperature defined in degrees Celsius). The condensation margin limit can be calibrated at installation of the engine system 10, determined on a periodic schedule (e.g., seasonally), or determined continually. In some embodiments, the condensation margin limit is user selectable and chosen from one of about five degrees Celsius (5° C.), or about ten degrees Celsius (10° C.). In some embodiments, the condensation margin limit also includes an associated pressure value that can be determined similar to the condensation margin limit temperature. In some embodiments, a condensation margin limit is determined based on a dew point temperature limit and outputted to HMI 184.

In some embodiments, the condensation margin pressure is about 2 bar or about 4 bar. In some embodiments, the condensation margin limit can include other temperatures and pressures, as desired for the particular engine system 10. The condensation margin limit can be determined based on the dew point temperature limit and the liquid flow rate can be determined based on the dew point temperature limit and the condensation margin limit. In some embodiments, the margin circuit 144 is structured to determine the following parameters:

$$a . Cond\_Margin ( C ) = Intake\_Man \_Temp - Dew\_Temp$$

$$b . Dew\_Temp \_Max ( C ) = Intake\_Man \_Temp - Cond\_Margin \_Limit$$

$$c . Intake\_Man \_Vapor \_Press \_Max ( mbar ) = f * EXP ( ( Dew\_Temp \_Max * b ) / ( Dew\_Temp \_Max + c ) )$$

$$d . Intake\_Man \_Spec \_Humidity \_Max ( kg / kg ) = ( ( d * Intake\_Man \_Vapor \_Press \_Max ) / ( Intake\_Man \_Press - e * Intake\_Man \_Vapor \_Press \_Max ) )$$

$$e . Water\_Flow \_Max ( kg / s ) = ( Intake\_Man \_Spec \_Humidity \_Max - Amb\_Spec \_Humidity ) * Air\_Flow ,$$

where Cond_Margin is the condensation margin limit, the Dew_Temp_Max is the dew point temperature maximum limit, the Intake_Man_Spec_Humidity_Max is the maximum intake manifold specific humidity, the Intake_Man_Vapor_Press Max is the maximum intake manifold vapor pressure, and the Water_Flow_Max is the maximum water flow. In some embodiments scaling factors b, c d, e and f may be the same numerical values as those described above or different.

The output circuit 148 is structured to communicate with the pump VFD 184, the HMI 180, the VFD fault reset 168, and the solenoid valve 66 to control operation of the liquid injection system 30 based on the determinations discussed above. In some embodiments, the output circuit 148 provides the Water_Flow_Max value to the solenoid valve 66 so that humidification is increased. This in turn results in a reduced emission output of the engine system 10 while reducing or inhibiting the formation of condensation within the manifold 26. Hence, such control allows for and can be performed to reduce emissions, including but not limited to NOx emissions.

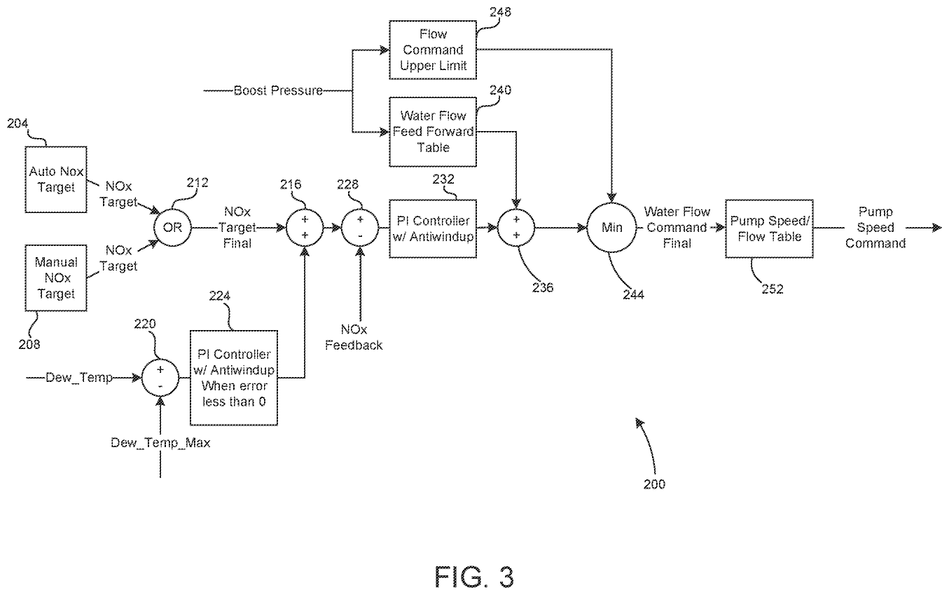

As shown in FIG. 3, the controller 100 is structured to provide a process flow 200 that includes receiving an automatically generated NOx target at step 204 and a manual NOx target at step 208. At step 212, the controller 100 selects one of the automatically generated NOx target or the manual NOx target and provides the selected target to a summation block 216. A summation/subtraction block 220 receives the dew point temperature and the maximum allowable dew point temperature (e.g., Dew_Temp_Max) and provides processed parameters to a PI (proportional and integral controller) control step 224 that includes an anti-wind up function (e.g., the elimination of error accumulation when approaching limits). Outputs of the PI control step 224 are provided to the summation block 216. Thus, the liquid injection system is configured to be operable in either a manual or an automatic mode that respectively manually receives (e.g., through manual entry by a user) or automatically provides a NOx target, and maintains a closed loop NOx control including determining the liquid flow rate to achieve the NOx target.

The summed parameters from the target NOx and PI control step 224 are provided to a summation/subtraction block 228 and processed using NOx feedback (e.g., from the NOx sensor 192). The summation/subtraction block 228 provides a current parameter list indicative of the target NOx, the current dew point temperature, the current maximum allowable dew point temperature (e.g., Dew_Temp_Max), and the current NOx output of the engine system 10. The output of the summation/subtraction block 228 is processed by a PI control step 232 including an anti-wind up function and the parameters are provided to a summation block 236. In some embodiments, the NOx target is received and used to determine one or more of a liquid flow rate based on the NOx target and a measured NOx output of the liquid injected engine system or a condensation margin limit which is ascertainable automatically based on the NOx target.

At step 240, boost pressure is used to query a liquid flow feed forward table and return a target liquid flow for injection. The returned target liquid flow value is provided to the summation block 236. The summation block 236 then determines water control parameters based on the received target liquid flow value and the parameters provided by the PI control step 232. The process flow 200 includes two separate PI control steps 224 and 232 which provide separate PI controls for automatic and manual operation modes and allow for separate gains. In some embodiments, a single PI control may be implemented.

At step 248, a flow command upper limit is determined based at least in part on the boost pressure. The flow command upper limit is provided to a minimum function 244 that acts to limit the target liquid flow value received from the summation block 236. Thus, the liquid flow rate is limited by a flow command upper limit.

In some embodiments, a NOx target is received and used to determine a liquid flow rate to achieve the target. For example, the minimum function 244 outputs a final liquid flow value that should be injected in the engine 10 to achieve the target NOx. At step 252, the final liquid flow value is used to query a pump speed/flow table and a pump VFD speed command is output to the pump VFD 184.

In some embodiments, one or more look up tables discussed in the process flow 200 can be replaced with machine learning or AI engines. In some embodiments, different parameters can be used to determine the final liquid flow value.

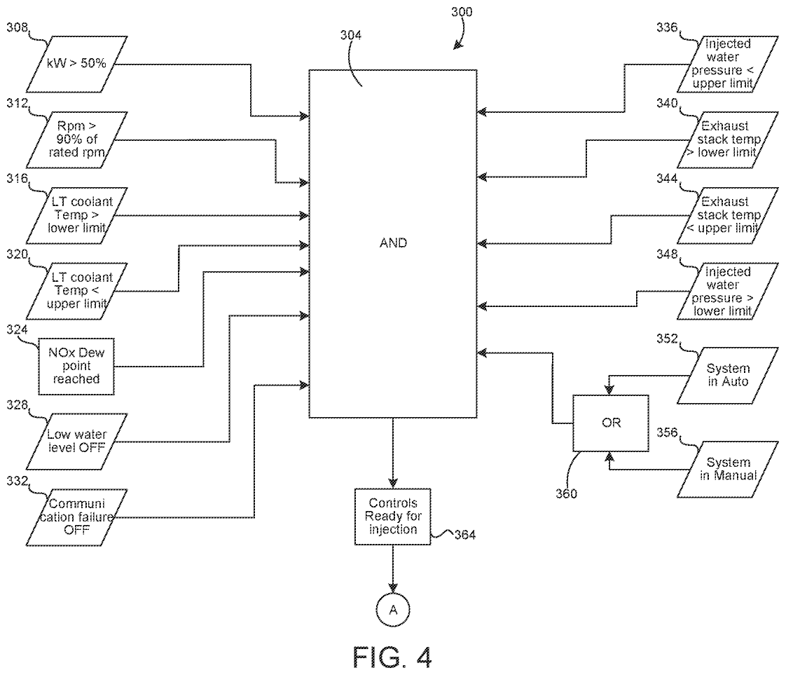

In some embodiments, a method of controlling a liquid injection system for an engine is provided. The method includes receiving temperature information indicative of a temperature within an air intake; receiving humidity information indicative of an inlet air humidity at the air intake; receiving pressure information indicative of an air pressure within the air intake; determining a dew point temperature limit based on the temperature information, the humidity information, and the pressure information; determining an exhaust emissions output; determining a liquid flow rate based on the dew point temperature limit, the liquid flow rate allowing a reduction of the exhaust emissions output; and controlling at least one of a pump or a water solenoid valve to provide the liquid flow rate. These and other aspects are described with respect to FIG. 4 below.

As shown in FIG. 4, a method 300 of determining control outputs of the controller 100 includes receiving inputs of the controller 100 at step 304. The inputs include one or more of: an engine load limit determination that the kW output of the engine system 10 is above a threshold (e.g., about 50%) at step 308, an engine speed limit determination that an engine revolution per minute (rpm) value is greater than a threshold (e.g., about 90% of an engine rated rpm) at step 312, a determination that a coolant temperature is greater than a lower limit at step 316, a determination that the coolant temperature is less than an upper limit at step 320, a NOx dew point reached input at step 324, a low water level off determination at step 328, a communication failure off determination at step 332, a determination that an injected water pressure is below an upper limit at step 336, a determination that an exhaust stack temperature is greater than a lower limit at step 340, a determination that the exhaust stack temperature is below an upper limit at step 344, a determination that the injected water pressure is greater than a lower limit at step 348, a determination that the controller 100 is in an automatic mode at step 352, a determination that the controller 100 is in a manual mode at step 356, and a determination as to whether an automatic mode or manual mode is selected at step 360.

In some embodiments, in the manual mode the liquid injection system 30 turns on the water pump 46 and maintains closed loop NOx control to the target specified by the user when liquid injection conditions are met.

The processors 108 are configured to be caused to inhibit at least one of the pump or the valve from providing the liquid flow rate when one or more liquid injection conditions are not met, and allow at least one of the pump or the valve to provide the liquid flow rate when one or more liquid injection conditions are met.

If the liquid injection conditions are not met, the water recirculation solenoid 66 is arranged in a recirculation position and the water pump 46 is off until liquid injection conditions are again met. Liquid injection is limited to a threshold (e.g., a maximum) set by the condensation margin calculation regardless of a user request. In the automatic mode the liquid injection system 30 turns on the water pump 46 and maintains closed loop NOx control to the maximum flow set by the condensation margin calculation when the liquid injection conditions are met. If the liquid injection conditions are not met, the water recirculation solenoid 66 is arranged in the recirculation position and the water pump 46 is off until the liquid injection limits are met. The controller 100 processes the inputs 308-360 at step 304 and determines control parameters at step 364.

In some embodiments, the inputs 308-360 are used to determine liquid injection conditions. In general, such conditions are indicative of when liquid injection can be performed without appreciable condensation (among other undesirable phenomena). In some embodiments, the conditions include: a) the kW Load greater than a calibratable limit in step 308, b) the engine speed greater than a calibratable limit in step 312, and c) the NOx Sensor Dewpoint Reached signal being equal to 1. Each condition can include a calibratable hysteresis to reduce or inhibit noise (e.g., signal chatter) near the limits. Thus, the method includes inhibiting the water pump and the water solenoid valve from providing the liquid flow rate when liquid injection conditions are not met, allowing the water pump and the water solenoid valve to provide the liquid flow rate when liquid injection conditions are met, in which liquid injection conditions include an engine load being greater than an engine load limit, an engine speed greater than an engine speed limit, and a NOx sensor dew point reached signal from an NOx sensor is received.

In some embodiments, the memory devices 112 is configured to store instructions that, when executed by one or more processors, cause the one or more processors to receive manifold temperature information indicative of a manifold temperature at a manifold; receive manifold pressure information indicative of a manifold pressure within the manifold; and determine the dew point temperature limit based on the temperature information, the humidity information, the pressure information, the manifold temperature information, and the manifold pressure information.

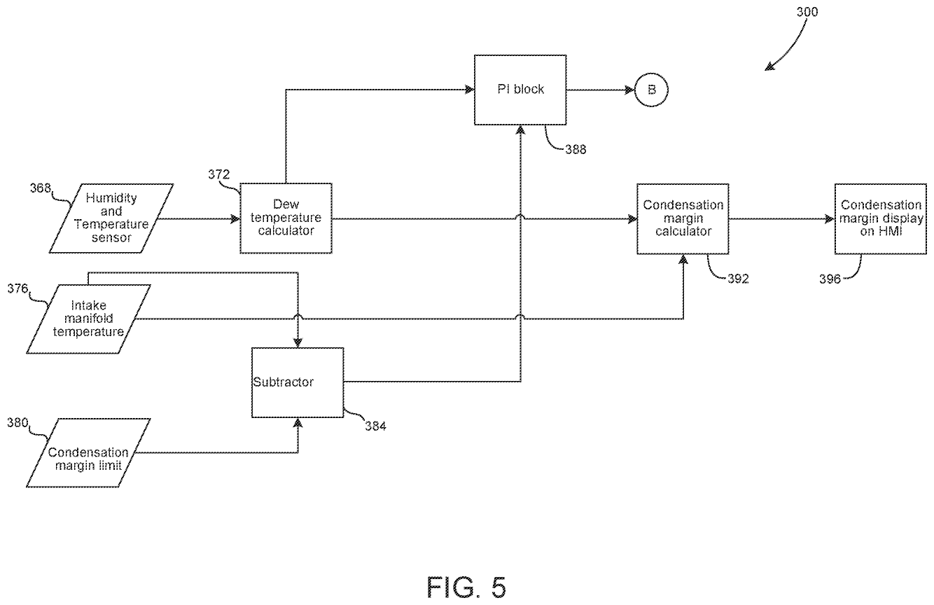

As shown in FIG. 5, the method 300 also includes receiving humidity and temperature sensor inputs at step 368. The method 300 further includes determining a dew point temperature at step 372. At step 376 an intake manifold temperature is received by the controller 100. At step 380, a condensation margin limit is received by the controller 100. As discussed above, the condensation margin limit is a calibratable value that can be automatically generated, user selected, or determined using look up tables or machine learning engines. In some embodiments, the condensation margin limit is determined based on information entered by a user. At step 384, a subtractor function is implemented to process the received intake manifold temperature and condensation margin limit.

At step 388 a PI control function processes the output of the subtractor function of step 384 and the outputs of the dew point calculator of step 372. At step 392, a condensation margin calculator determines the condensation margin temperature. In some embodiments, the condensation margin temperature corresponds to the limiting temperature for operation of the liquid injection system 30. The condensation margin calculator is configured to determine the condensation margin temperature based on the intake manifold pressure and the outputs of the dew point temperature calculation of step 372. At step 396, the condensation margin temperature is displayed on the HMI 180.

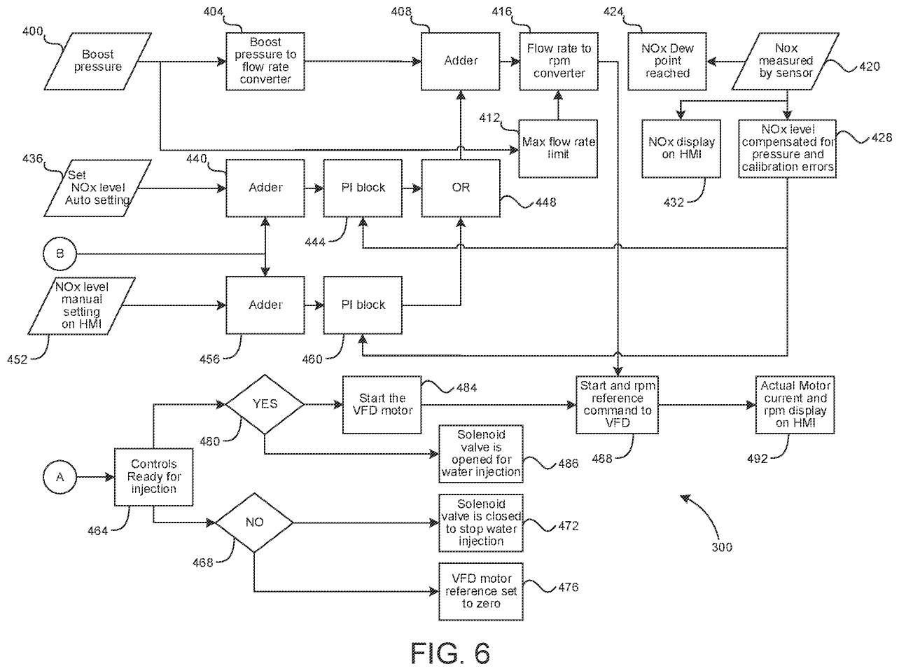

As shown in FIG. 6, the method 300 also includes receiving boost pressure information at step 400, and converting the boost pressure information to flow rate information at step 404. At step 408, the flow rate information is provided to an adder function. At step 412, a flow rate limit (e.g., a maximum flow rate limit) is determined based on the boost pressure information. At step 416, a flow rate to rpm converter receives information from the adder function of step 408 and the maximum flow rate limit from step 412, and outputs a revolutions per minute (rpm) value. In some embodiments, information relating to the rpm of the pump is outputted to HMI 180.

At step 420, NOx information is provided to the controller 100 by the NOx sensor 192. It is determined at step 424 if a NOx dew point is reached. At step 428, the measured NOx level is compensated for in view of pressure and calibration errors. At step 432, the NOx information is displayed on the HMI 180.

At step 436, NOx level auto settings are received, and then provided to an adder function at step 440 in addition to the outputs of the PI function block of step 388 from FIG. 5. In some embodiments, the NOx level auto settings may be set in advance, e.g., hardcoded. The combined NOx level auto settings and PI function output is provided to a PI function at step 444. The outputs of the compensated NOx level from step 428 are also provided to the PI function at step 444. The outputs of the PI function are then provided to an OR function at step 448.

At step 452, NOx level manual settings are received via user entry on the HMI 180, and then provided to an adder function at step 546 in addition to the outputs of the PI function block of step 388 from FIG. 5. The combined NOx level auto settings and PI function output is provided to a PI function at step 460. The outputs of the compensated NOx level from step 428 are also provided to the PI function at step 460. The outputs of the PI function are then provided to an OR function at step 448.

The NOx parameters and information selected by the OR function at step 448 are provided to the adder function at step 408 and affect the determination of the RPM at step 416.

At step 464, the control parameters from step 364 in FIG. 4 are then received and processed for injection to the control. If the control parameters are not met at step 468, then commands are sent to the solenoid valve 66 to close and stop liquid injection at step 472. For example, if the control parameters are not met, then the conditions for water injection are deemed not to be present. Such conditions (that is, conditions when the control parameters are not met) are indicative of the potential for water injection to result in condensation within the manifold. If the control parameters are not met at step 468, the pump VFD 184 is controlled to not turn the motor 50 so that no pump pressure is provided.

If the control parameters are met (e.g., conditions for liquid injection do exist and would not result in condensation within the manifold) at step 480, then commands are sent to start the pump VFD 184. The VFD 184 is commanded to start and to provide water pressure with the pump 54 at step 484. At step 486, command output is provided to the solenoid valve 66 to open and provide liquid injection.

At step 488, the RPM output from step 416 is provided to the pump VFD 184 to control the pump pressure and speed. At step 492, the actual motor speed (RPM) and current are displayed on the HMI 180. The HMI 180 may have a display interface, e.g., a touch screen, a monitor, or other device featuring a display screen.

The systems and methods discussed above provide a determination of a dew point temperature limit that acts as a threshold for temperature and pressure at which condensation is likely to form in an intake manifold of an engine. The systems and methods determine a condensation margin below which condensation within the manifold could occur (e.g., 10° C.). A liquid injection system is then controlled to minimize emissions of NOx while maintaining conditions outside the condensation margin. This allows the systems and methods to significantly improve the engine system's ability to reduce NOx emissions. Further, in addition, such reduction in NOx emissions is achieved while inhibiting the formation of condensation within the manifold, thereby reducing the detrimental effects of liquid condensation.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 2, it should be understood that the controller 100 may include any number of circuits for completing the functions described herein. For example, the activities and functionalities of the circuits of the control system 116 may be combined in multiple circuits or as a single circuit. Additional circuits with additional functionality may also be included. Further, the controller 100 may further control other activity beyond the scope of the present disclosure.

As mentioned above and in one configuration, the “circuits” may be implemented in machine-readable medium for execution by various types of processors, such as the processor 108 of FIG. 2. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the system, for example the one or more processors may be a remote processor (e.g., a cloud based processor). Alternatively or additionally, the one or more processors may be internal and/or local to the system. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods can be accomplished with standard programming techniques with rule-based logic and other logic to accomplish the various connection steps, processing steps, comparison steps, and decision steps.

As used herein, the terms “about” or “approximately” when preceding a numerical value indicates the value plus or minus a range of 10% or 15% of the value. As will be understood by one skilled in the art, all ranges disclosed herein also encompass any and all possible subranges and combinations of subranges thereof, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

It is important to note that the construction and arrangement of the engine system 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A liquid injection system for an engine system, comprising:
one or more processing circuits comprising one or more memory devices coupled to one or more processors, the one or more memory devices configured to store instructions thereon that, when executed by the one or more processors, cause the one or more processors to:
receive temperature information indicative of a temperature within an air intake;
receive humidity information indicative of an inlet air humidity at the air intake;
receive pressure information indicative of an air pressure within the air intake;
determine a dew point temperature limit based on the temperature information, the humidity information, and the pressure information;
determine an exhaust emissions output;
determine a liquid flow rate based on the dew point temperature limit, the liquid flow rate allowing for a reduction of the exhaust emissions output; and
control at least one of a pump or a valve to provide the liquid flow rate.

2. The liquid injection system of claim 1, wherein the one or more memory devices are further configured to store instructions thereon that, when executed by the one or more processors, cause the one or more processors to:
receive a NOx target; and
determine the liquid flow rate to achieve the NOx target.

3. The liquid injection system of claim 1, wherein the one or more memory devices are further configured to store instructions thereon that, when executed by the one or more processors, cause the one or more processors to:
inhibit at least one of the pump or the valve from providing the liquid flow rate when one or more liquid injection conditions are not met; and
allow at least one of the pump or the valve to provide the liquid flow rate when one or more liquid injection conditions are met.

4. The liquid injection system of claim 3, wherein the one or more liquid injection conditions include:
an engine load greater than an engine load limit;
an engine speed greater than an engine speed limit; and
a NOx sensor dew point reached signal is received.

5. The liquid injection system of claim 1, wherein the one or more memory devices are further configured to store instructions thereon that, when executed by the one or more processors, cause the one or more processors to:
determine a condensation margin limit based on the dew point temperature limit; and
determine the liquid flow rate based on the dew point temperature limit and the condensation margin limit.

6. The liquid injection system of claim 5, wherein the one or more memory devices are further configured to store instructions thereon that, when executed by the one or more processors, cause the one or more processors to:
determine the condensation margin limit based on information entered by a user.

7. The liquid injection system of claim 5, wherein the one or more memory devices are further configured to store instructions thereon that, when executed by the one or more processors, cause the one or more processors to:
receive a NOx target; and
determine the condensation margin limit automatically based on the NOx target.

8. The liquid injection system of claim 1, wherein the one or more memory devices are further configured to store instructions thereon that, when executed by the one or more processors, cause the one or more processors to:
receive manifold temperature information indicative of a manifold temperature at a manifold;
receive manifold pressure information indicative of a manifold pressure within the manifold; and
determine the dew point temperature limit based on the temperature information, the humidity information, the pressure information, the manifold temperature information, and the manifold pressure information.

9. The liquid injection system of claim 1, wherein the one or more memory devices are further configured to store instructions thereon that, when executed by the one or more processors, cause the one or more processors to:
control the pump including sending control commands to a variable frequency drive to provide the liquid flow rate.

10. The liquid injection system of claim 1, wherein the one or more memory devices are further configured to store instructions thereon that, when executed by the one or more processors, cause the one or more processors to:
determine a condensation margin limit based on the dew point temperature limit; and
output the condensation margin limit to a human machine interface.

11. The liquid injection system of claim 1, wherein the one or more memory devices are further configured to store instructions thereon that, when executed by the one or more processors, cause the one or more processors to:
output information relating to a pump motor revolution per minute value to a human machine interface.

12. The liquid injection system of claim 1, wherein the one or more memory devices are further configured to store instructions thereon that, when executed by the one or more processors, cause the one or more processors to:
limit the liquid flow rate by a flow command upper limit.

13. The liquid injection system of claim 1, wherein the one or more memory devices are further configured to store instructions thereon that, when executed by the one or more processors, cause the one or more processors to:
receive the temperature information, the humidity information, and the pressure information from a combination sensor of the engine system, the combination sensor being configured to sense relative humidity, temperature, and pressure.

14. The liquid injection system of claim 1, wherein the one or more memory devices are further configured to store instructions thereon that, when executed by the one or more processors, cause the one or more processors to:
operate the liquid injection system in an automatic mode that automatically provides a NOx target; and
maintain a closed loop NOx control including determining the liquid flow rate to achieve the NOx target.

15. The liquid injection system of claim 1, wherein the one or more memory devices are further configured to store instructions thereon that, when executed by the one or more processors, cause the one or more processors to:
operate the liquid injection system in a manual mode that receives a NOx target manually entered by a user; and
maintain a closed loop NOx control including determining the liquid flow rate to achieve the NOx target.

16. A liquid injected engine system, comprising:
a water manifold;
a water tank;
a water pump fluidly coupled to the water tank;
a water solenoid valve selectively coupling a water injector nozzle with the water pump; and
a controller structured to:
determine a dew point temperature limit based on temperature, pressure, and humidity information of the water manifold;
determine a condensation margin limit based on the dew point temperature limit;
determine a liquid flow rate based on the dew point temperature limit and the condensation margin limit; and
control the water pump and the water solenoid valve to provide the liquid flow rate to the water injector nozzle.

17. The liquid injected engine system of claim 16, wherein the controller is further structured to:
receive a NOx target; and
determine the liquid flow rate based on the NOx target and a measured NOx output of the liquid injected engine system.

18. A method of controlling a liquid injection system for an engine, comprising:
receiving temperature information indicative of a temperature within an air intake;
receiving humidity information indicative of an inlet air humidity at the air intake;
receiving pressure information indicative of an air pressure within the air intake;
determining a dew point temperature limit based on the temperature information, the humidity information, and the pressure information;
determining an exhaust emissions output;
determining a liquid flow rate based on the dew point temperature limit, the liquid flow rate allowing for a reduction of the exhaust emissions output; and
controlling at least one of a pump or a water solenoid valve to provide the liquid flow rate.

19. The method of claim 18, further comprising:
inhibiting the water pump and the water solenoid valve from providing the liquid flow rate when liquid injection conditions are not met; and
allowing the water pump and the water solenoid valve to provide the liquid flow rate when liquid injection conditions are met,
wherein the liquid injection conditions include:
an engine load greater than an engine load limit;
an engine speed greater than an engine speed limit; and
a NOx sensor dew point reached signal from an NOx sensor is received.

20. The method of claim 19, further comprising displaying at least information from the NOx sensor on a human machine interface.
